(19) United States
(12) Patent Application Publication
(10) Pub. No.: US 2017/0091847 A1
(43) Pub. Date: Mar. 30, 2017

(54) AUTOMATED FEATURE IDENTIFICATION BASED ON REVIEW MAPPING

(71) Applicant: INTERNATIONAL BUSINESS MACHINES CORPORATION, ARMONK, NY (US)

(72) Inventors: KARL J. CAMA, COLLEYVILLE, TX (US); NORBERT HERMAN, DENVER, CO (US); SHUBHADIP RAY, SOMERSET, NJ (US)

(21) Appl. No.: 14/868,449

(22) Filed: Sep. 29, 2015

(51) Int. Cl. G06Q 30/06; G06Q 50/00; G06F 17/30; G06Q 30/02

(52) U.S. Cl. CPC G06Q 30/0629; G06Q 30/0206; G06Q 50/01; G06F 17/30528; G06F 17/3053; G06F 17/30867

(57) ABSTRACT

Aspects determine purchasing intent by mapping desired item features to item price values that the user will pay. Item features and price values are identified within data of reviews, and positive values assigned to each that are matched to features or prices of the mapped user intent. Helpfulness scores are determined for each of the reviews by totaling the positive values assigned to the matched features and price values, and used to prioritize reviews displayed to a user. In some aspects user customer base clusters are formed as a function of commonalities of feature to price value mappings of high helpfulness score reviews to identify most valued features for prices paid for future product offerings.

### BACKGROUND

Product designers and manufacturers have the ability to select between a wide variety of alternative features and product attributes in order to generate products for offer to consumers and other users for purchase, rental, etc. Many products miss expectations for sales and general user acceptance as a function of a failure to meet consumer and other end user expectations. In part this is due to a failure to identify which key features and attributes the end user expects or satisfies user needs at any given price point, relative to competing products.

Accordingly, product designers and manufacturers often generate multiple versions of a product that differ with respect to one or more distinguishing features or attributes of the products, in order to generate at least one version that meets the needs and expectations of end users or consumers. This presents problems for comparison for the end user/consumer, particularly where the end user relies on reviews and other third party assessments of the competing products for information useful in deciding between the products. Products that are offered in multiple, different versions may also generate multiple reviews and social network commentary that are not comparable or even conflict, due to differences in the features and attributes considered in the review and commentary content. This diminishes the usefulness of reviews and other third party content considered by the consumer for assistance in making a purchase decision between competing products.

### SUMMARY

In one aspect of the present invention, a method for determining purchasing intent as a function of mapping item features in reviews to user transaction history includes a processor determining a user intent with respect to purchasing an item by mapping features of the item that are indicated as desired by the user, to price values of the item that are indicated that the user will pay, as a function of historic network communication and transaction data content of the user. Features and price values of the item are identified within data of reviews of the item, and positive values assigned to each feature and price value of the reviews that are matched to features or price value of the item that are mapped in the user intent. Helpfulness scores area determined for each of the reviews by totaling the positive values assigned to the matched features and price values of the reviews, and a graphical display device is driven to display to the user the reviews prioritized with respect to their helpfulness scores. In some aspects, the user is clustered with other, different users into a customer base cluster as a function of commonalities of mappings of features to price values, and links are determined between the different features, prices and other item variable values in the reviews with high helpfulness scores relative to a score threshold or to others of the reviews that have lower helpfulness scores, to identify most valued features for prices paid by the users in the customer base cluster for use in designing a future product offering to customers of the item that includes the set of features as a function of the identified price point for the set of features.

In another aspect, a system has a hardware processor in circuit communication with a computer readable memory and a computer-readable storage medium having program instructions stored thereon. The processor executes the program instructions stored on the computer-readable storage medium via the computer readable memory and thereby determines a user intent with respect to purchasing an item by mapping features of the item that are indicated as desired by the user, to price values of the item that are indicated that the user will pay, as a function of historic network communication and transaction data content of the user. Features and price values of the item are identified within data of reviews of the item, and positive values assigned to each feature and price value of the reviews that are matched to features or price value of the item that are mapped in the user intent. Helpfulness scores area determined for each of the reviews by totaling the positive values assigned to the matched features and price values of the reviews, and a graphical display device is driven to display to the user the reviews prioritized with respect to their helpfulness scores. In some aspects, the user is clustered with other, different users into a customer base cluster as a function of commonalities of mappings of features to price values, and links are determined between the different features, prices and other item variable values in the reviews with high helpfulness scores relative to a score threshold or to others of the reviews that have lower helpfulness scores, to identify most valued features for prices paid by the users in the customer base cluster for use in designing a future product offering to customers of the item that includes the set of features as a function of the identified price point for the set of features.

In another aspect, a computer program product for determining purchasing intent as a function of mapping item features in reviews to user transaction history has a computer-readable storage medium with computer readable program code embodied therewith. The computer readable program code includes instructions for execution which cause the processor to determine a user intent with respect to purchasing an item by mapping features of the item that are indicated as desired by the user, to price values of the item that are indicated that the user will pay, as a function of historic network communication and transaction data content of the user. Features and price values of the item are identified within data of reviews of the item, and positive values assigned to each feature and price value of the reviews that are matched to features or price value of the item that are mapped in the user intent. Helpfulness scores area determined for each of the reviews by totaling the positive values assigned to the matched features and price values of the reviews, and a graphical display device is driven to display to the user the reviews prioritized with respect to their helpfulness scores. In some aspects, the user is clustered with other, different users into a customer base cluster as a function of commonalities of mappings of features to price values, and links are determined between the different features, prices and other item variable values in the reviews with high helpfulness scores relative to a score threshold or to others of the reviews that have lower helpfulness scores, to identify most valued features for prices paid by the users in the customer base cluster for use in designing a future product offering to customers of the item that includes the set of features as a function of the identified price point for the set of features.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts a computerized aspect according to an embodiment of the present invention.

FIG. 4 is a flow chart illustration of a method or process according to an embodiment of the present invention for determining purchasing intent as a function of mapping item features in reviews to user transaction history.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

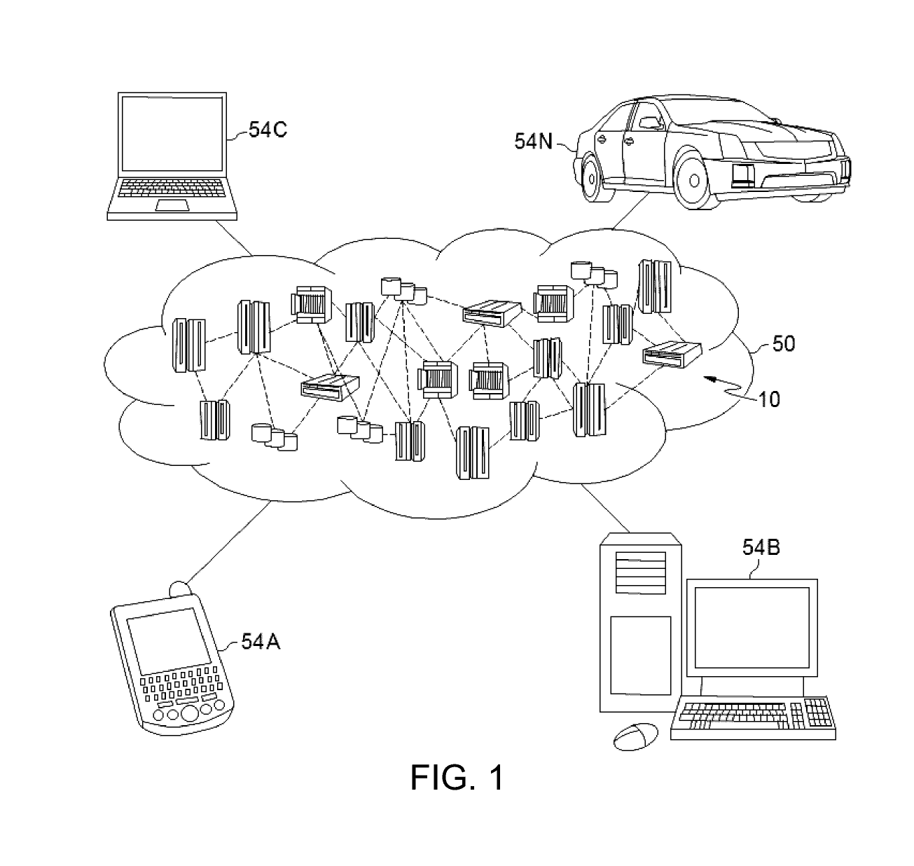

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

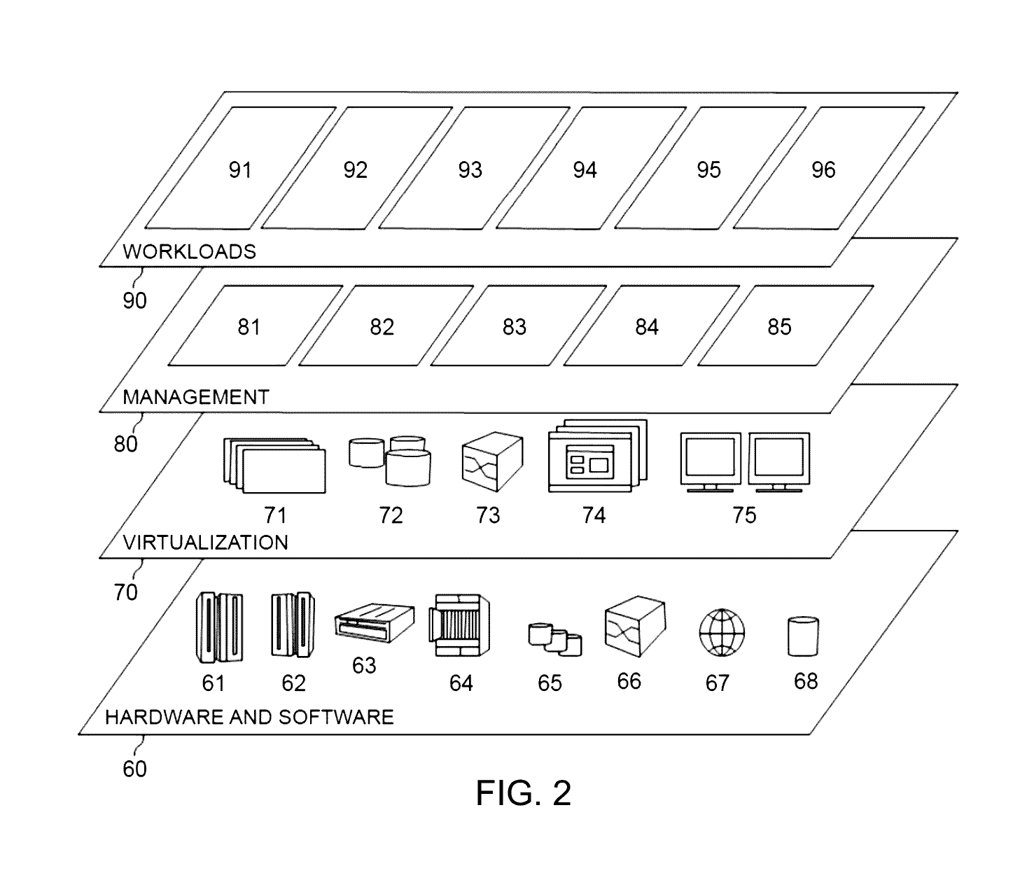

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 for determining purchasing intent as a function of mapping item features in reviews to user transaction history as described below.

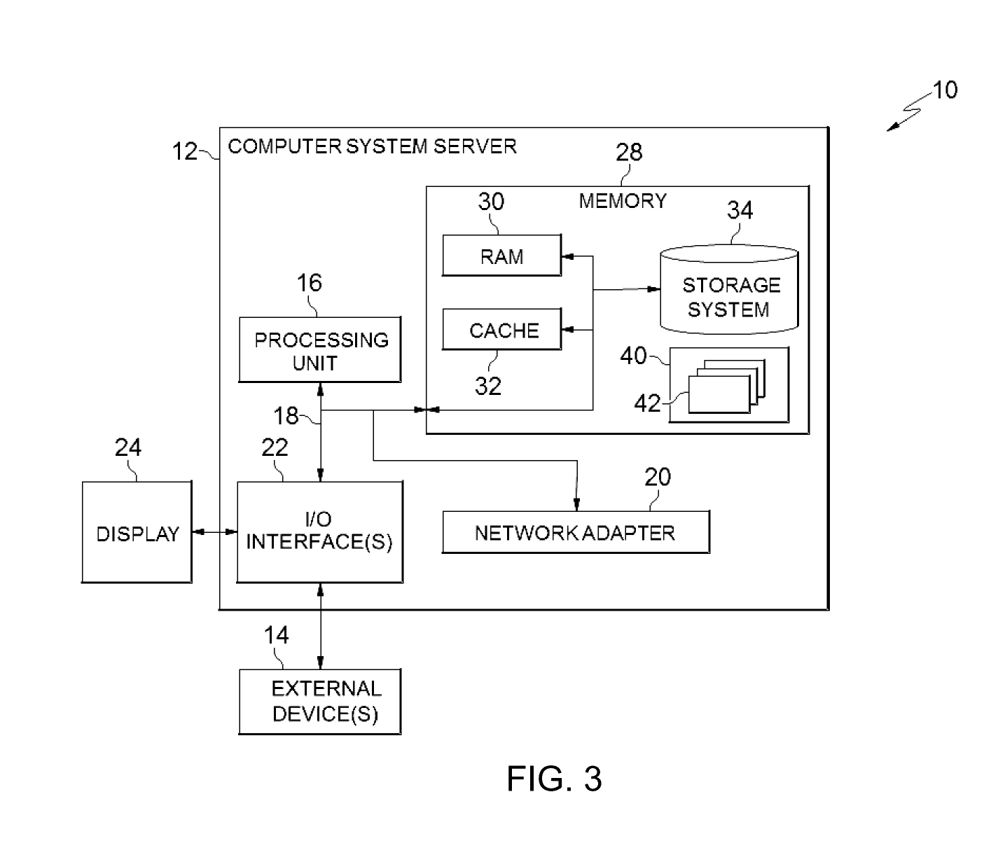

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

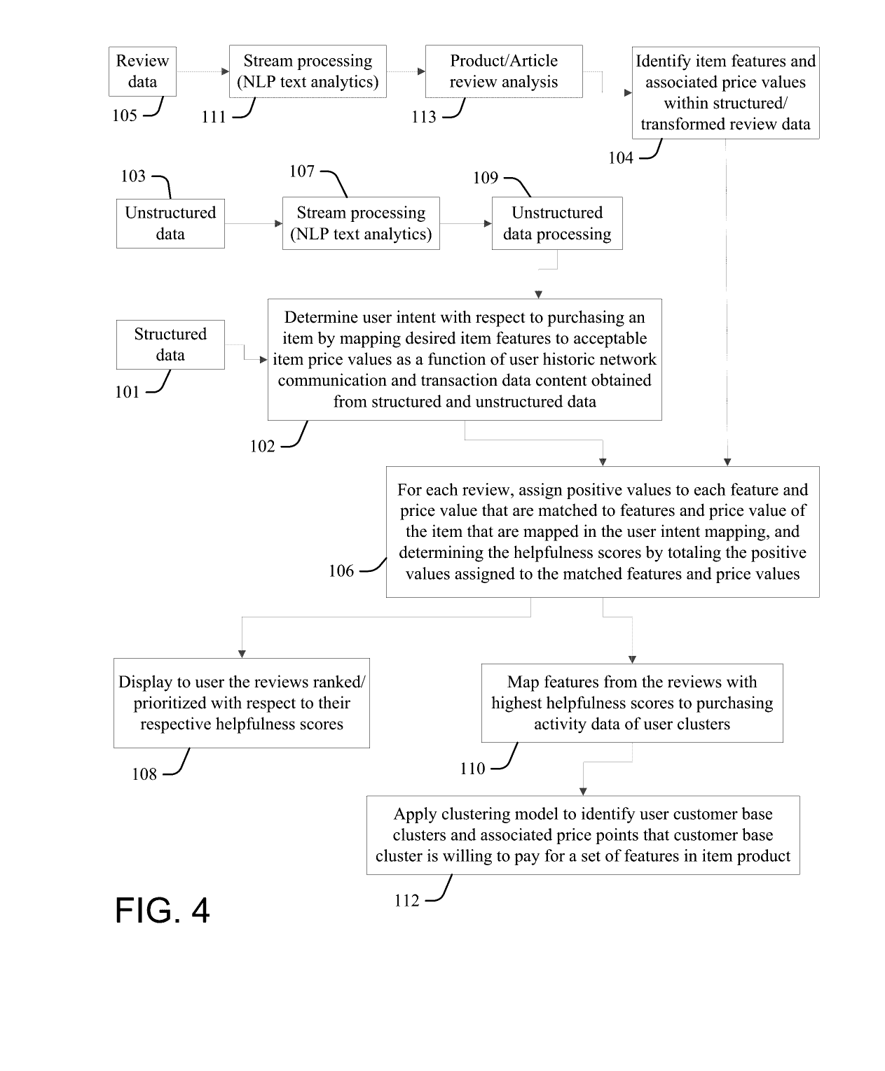

FIG. 4 (or “FIG. 4”) illustrates a computer implemented method or process of an aspect of the present invention for determining purchasing intent as a function of mapping item features in reviews to user transaction history. A processor (for example, a central processing unit (CPU)) executes code, such as code installed on a storage device in communication with the processor, and thereby performs the following process step elements illustrated in FIG. 4. With respect to aspects of the present invention, the term “user” will be understood to comprehend generically an end user, customer consumer or other decision maker responsible for a purchasing or other selection decision between competing item products or services. “Purchasing an item” will be understood to comprehend generically the acceptance of an offer for sale of goods or services with respect to an item that has a different combination of features and pricing relative to a competing, similar item that may satisfy the purchaser's (user's) requirements.

At 102, a customer intent data hub process determines or defines a user intent with respect to purchasing an item by mapping features of the item that are indicated as desired by the user, to acceptable price values of the item that are indicated that the user will pay, as a function of historic network communication and transaction data content of the user. The historic data content is defined by or processed directly from structured data 101 of (or related to) the user, and from unstructured data 103 of/related to said user via intervening stream processing of Natural Language Processing (NLP) text analytics 107 and further user unstructured data processing at 109.

Structured data is generally stored and organized in fixed fields that are defined within relational database and spreadsheet data records or files according to a data model that enables data processing and access. Structured data models define what fields of data will be stored, how that data will be stored, data type (for example, numeric, currency, alphabetic, name, date, address) and any restrictions on the data input (for example number of characters; restrictions to certain string text terms such as “Mr., Ms. or Dr.; M or F”, etc.). Structured data is easily entered, stored, queried and analyzed, generally using Structured Query Language (SQL), a programming language created for managing and querying data in relational database management systems.

Examples of structured historic network communication and transaction data content 101 ingested and processed to determine mappings at 102 include user cookies and browsing history data, for example, what item features the user has searched for, in what sequences of searches, which retailer sites are represented within cookie data, and any pricing values contained therein, etc. Transaction and other purchase history data may identify which items having which features the user has previously purchased, and at what price points. User profile demographic data values (age, geographic location, gender, political affiliation, religious affiliation, group memberships, etc.) may be linked to purchasing data. Current user context (for example, recent changes (increases or decreases) in purchasing power indicated by salary data associated with changes in user job status (title, employer, employment, etc.), or in needs due to changes in family structure due to recent marriage, birth of a child, addition of son or daughter-in-law through marriage, etc.) may be linked or associated with item feature purchasing and pricing data. User click-stream history may identify feature and price data combinations on web pages that lead to click-through toward further inquiries and/or purchases. User social media footprint data, location and timing of searches, and purchasing history unique to a particular computing device may also provide structured data associations useful in mapping desired feature data to price data values. Still other examples will be apparent to one skilled in the art

Unstructured data may include semi-structured data and comprehends subject matter that isn't readily classifiable or otherwise lacks data model structure attributes defined by structured data models. For example, tags or other types of markers may be used to identify certain elements within the data, but wherein the data doesn't have a rigid structure. A word processing application file may include structured metadata such as author name and date created, and unstructured text content. Photos or other graphics may have structured keyword tag data (for example, creator, date, location, etc.), but the image data itself may be unstructured graphic data (bitmap values, etc.).

Examples of the unstructured data 103 include user survey text data, search text strings, call center notes data generated through interaction with the user, and text data appearing with social media activity data of the user, and still others will be apparent to one skilled in the art. This data is initially stream processed by the NLP text analytics component 107 to transform raw text content into semi-structured and structured data forms, which is in turn processed by additional user unstructured data processing at 109 that includes one or more of psycholinguistic library analytics, descriptive and prescriptive analytic models and clustering analyzer models to identify and map feature and price data values derived from or associated with the unstructured text content. Users with similar determined item purchasing intents are grouped together by applying clustering models to derive common customer bases for features and price points. Some aspects use Bayesian inference analysis to identify causal relationships and establish predictive inference of correlated data points. Thus, patterns are developed to map correlations detected between customers and what they are looking for in the structured 101 and unstructured 103 data.

Unstructured text content within review data 105 is stream processed by an NLP text analytics component 111, and additional product or article review analysis is performed at 113 to transform unstructured data from the reviews 105 into identified features and price values of the item data. Processing at 113 includes one or more of psycholinguistic library analytics, descriptive and prescriptive analytic models and clustering analyzer models that provide results that enable effective or accurate interpretation of the product review data, via clustering commonalities of features the reviews stress or cater to, and determinations of value for price. In some aspects positive and negative qualitative assessments of items that are associated with the identified features and price data within unstructured review text content is also transformed into structured feature data at 113. Social data may be processed at 113 based on pre-determined filters to ensure quality of data sets acquired or streamed from providers.

At 104 features of the item and associated price values are identified within the structured data of the raw review data 105 and within data transformed from unstructured data by the processes at 111 and 113. More particularly, structured review data 105 such as tags, numbers of rating stars or other objective quality metrics, click-stream information, transaction information and mapped feedback may be directly processed at 104, without intervening processes at 111 or 113. The review data 105 may also be ingested and processed based on filters or thresholds with regard to features and feature combinations or sets, values of same as a function of price, etc. Filters and thresholds may be adjusted as needed to ensure minimum amounts of data, or to limit data considered to maxim, management amounts, in order to ensure or increase accuracy or useful structure of analysis output data.

Processing at 104 includes aggregating reviews and analyzing for aggregate patterns and trends on objective and subjective valuations of products or their features that are useful in business decisions for improving the offers made to customers, as is discussed below with respect to elements 110 and/or 112.

At 106 a mapping and scoring engine determines helpfulness scores for each review for the user as a function of matching the review data values generated at 104 (the identified item features and associated price values) to user's intent values determined at 102, by assigning a positive value to each feature and price value of the reviews that are matched to features and price value of the item that are mapped in the user intent mapping, and determining the respective helpfulness scores for each of the reviews by totaling the positive values assigned to the matched features and price values for the reviews. In some aspects the matching assigns binary values, such as a “one” for a match and a “zero” for a mismatch, though other scoring scales and methods may be practiced. The scores for all possible dimensions, or only those of interest (features, values for price paid, durability, etc.) for the item that the user is interested in are added (summed together) to derive the final helpfulness score.

For example, where a user intent determined at 102 is to look for a red baby carrier, the process at 106 may assign a match value to a first review input at 105 that is identified at 104 to comprehend text discussion about any color (red or otherwise) of the baby carrier product. This will result in a higher total “helpfulness score” for the first review relative to the score assigned to another, second review input at 105 that has similar individual match scores on other features, price and attributes of a baby carrier product as determined at 104, but has a “zero” or other lower match score on the color attribute, so that its total, final helpfulness score will be lower.

At 108 a personalized sequencing engine displays to the user the reviews as ranked or prioritized with respect to their respective helpfulness scores. Thus, in the example above the first review is ranked higher, and identified as relatively more helpful, than the second review. This puts reviews matching the individual user's intent at the top, which may drive faster purchase decisions and increased sales, relative to prior art processes that sort review results based on other criteria that are not related or relevant to the user's intent (for example, time or date of review, source of review, or other generic source and review ranking algorithms that are independent or are not otherwise drawn to emphasize the users intent values).

At 110 an insights plotting engine maps features from the reviews with highest helpfulness scores to purchasing activity data of the user clusters determined at 102 or 104. As noted above, processing at 104 includes aggregating reviews and analyzing for aggregate patterns and trends on objective and subjective valuations of products or their features by the clustered users and reviewers, and more particularly as a function of commonalities of mappings of features to price values. Thus, association processes at 110 determine links between the different feature, price and other item variable values in most helpful reviews (reviews with high helpfulness scores) to determine or identify most valued features for prices paid by clustered users. Association and classification processes at 110 derive the most valued features from reviews with high helpfulness scores, and predictive analytical models are used to predict correlation between features and user's perceived value for price paid. Thus the most important features and enhancements to add to customer's perceived value for price paid are derived.

At 112 a product strategy recommendation engine applies clustering models to identify user customer base clusters and associated price points that the customer base cluster is willing to pay for a set of features in an item product. The association of the product features offered in a product/product version with the customer base is thus used derive a future product offering, wherein a price point may be identified that the customer base cluster users are willing to pay for a set of features in a product as a function of a commonality of a price value within the transaction data content of the customer base cluster users. A suggested retail price for a product offering to customers of the item that includes the set of features may be set as a function of the identified price point for this set of features. Predictive analytical models may also be applied to predict future demand in products and product features based on customer interest and future events.

Thus, future production and manufacturing decisions can be made based on the product strategies recommended at 112. Aspects may use personalized scoring of review feedback with customer intent and predictive analytics for predicting what products and what product features should be created that will yield higher sales and recommending future product strategy and roadmap for product innovation, design, enhancement, fixes, roll out and pricing strategies.

Aspects enable information product designers to design new products and features which they know are going to be popular with most of their customers, in part based on user clustering. Manufacturers and suppliers can then stock their shelves with only the most popular items with the most sought after features, wherein less choice will actually and counter intuitively lead to more sales and better satisfied customers. Product features offered in a particular item product or product version may be associated with customer interest as defined by user clusters to derive future product offerings.

Customers convey feedback and insight through product reviews about their intent, purpose and interest. Aspects of the present invention may readily recognize positive and negative intent in reviews and rating reviews based on customer certification criteria. Reviews differ from person to person and are time sensitive—to reflect the changing nature and life events of a customer. Personalized review scoring at 104 takes into consideration multiple attributes and dimensions specific to an individual, using the data derived from matching customer intent with product review content having high relative helpfulness scores to auto-predict future product strategies for different customer segments. Aspects may thereby identify feature enhancements which are perceived to deliver high value or quality for certain price point values, and correlate product features configurations with different price points, resulting in better identification of what the customers are really looking for, and better matching of products to customer interests and desires relative to prior art techniques.

Aspects of the present invention solve problems in efficiently and automatically deriving and adjusting product strategy in real time as a function of individual customer data or data from clusters of customers, determining which next features need to be part of evolving a product, which features will be most popular and match needs in which customer clusters, which features will provide most value for price paid, what will be the demand for certain new features, etc. Aspects consider (process) historic data from past experience of customers (reviews, feedback, surveys, etc.) and future insight data as to what new customers are looking for, in real time by extracting features which score high or highest based on both of the historic and future insight data, for individual and clusters of customers. However, it will be understood that some embodiments may not have these potential advantages, and these potential advantages are not necessarily required of all embodiments.

In one example an aspect determines at 102 that a first user looking for a baby carriage is the parent of an infant girl that is less than six months old, that unstructured social media text data from the first user includes a statement that the user prefers baby carrier products that have better head and neck rest support relative to other carriers, that the first user search and click-through data indicates interest costlier features options, and that an update on a social media profile of the first user indicates a promotion for which economic pay data for this user indicates that the promotion is likely associated with a salary increase of a certain percentage value or a certain base salary.

The intent of this user determined at 102 will be different from distinguished from the intent of a second user that is the parent of an older child (for example, a 3-year old) who has expressed in unstructured text content (in an email to a friend) key concerns about the ability of carriage to perform safely while transporting children having high body weight, reviews about safety harness configurations and agency safety ratings, and wherein no indication of interest in product color is determined.

In another example, reviews with high average helpfulness scores about the pros and cons of screen sizes of smart phones may be matched to user intents that include hand size feature data indicated from the ingested data 101 and 103 (for example, the user or cluster to which the user is assigned may be of a demographic group known to prefer small screen sizes over processing power as important selection criteria.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining purchasing intent as a function of mapping item features in reviews to user transaction history, the method comprising executing on a computer processor the steps of:
determining a user intent with respect to purchasing an item by mapping features of the item that are indicated as desired by the user, to price values of the item that are indicated that the user will pay, as a function of historic network communication and transaction data content of the user;
identifying the features and price values of the item within data of each of a plurality of reviews of the item;
assigning a positive value to each feature and price value of the reviews that are matched to features or price value of the item that are mapped in the user intent mapping;
determining helpfulness scores for each of the reviews by totaling the positive values assigned to the matched features and price values of the reviews; and
driving a graphical display device to display to the user the reviews prioritized with respect to their helpfulness scores.

2. The method of claim 1, further comprising:
clustering the user with a plurality of different users into a customer base cluster as a function of commonalities of mappings of features to price values; and
determining links between the different features, prices and other item variable values in the reviews with high helpfulness scores relative to a score threshold or to others of the reviews that have lower helpfulness scores, to identify most valued features for prices paid by the users in the customer base cluster.

3. The method of claim 2, further comprising:
identifying a price point that the customer base cluster users are willing to pay for a set of features in a product as a function of a commonality of a price value within transaction data content of the customer base cluster users; and
setting a suggested retail price for a future product offering to customers of the item that includes the set of features as a function of the identified price point for the set of features.

4. The method of claim 2, wherein the step of identifying the features and the price values of the item within the data of the reviews of the item comprises processing unstructured text data of each of a plurality of reviews of the item, and structured ratings data of each of the reviews.

5. The method of claim 2, wherein the step of determining the user intent with respect to purchasing the item by mapping features of the item that are indicated as desired by the user to the price values of the item that are indicated that the user will pay as the function of historic network communication and transaction data content of the user comprises processing structured data of the historic network communication and transaction data content that comprises user cookies, user browsing history, user transaction history data that identifies features of the item that the user has previously purchased and at what price, and user demographic data linked to purchasing data and recent changes in purchasing power indicated by salary data associated with changes in user job status or in needs due to changes in family structure of the user.

6. The method of claim 2, wherein the step of determining the user intent with respect to purchasing the item by mapping features of the item that are indicated as desired by the user to the price values of the item that are indicated that the user will pay as the function of historic network communication and transaction data content of the user comprises processing unstructured data of the historic network communication and transaction data content by applying at least one of natural language processing text analysis, psycholinguistic analysis, and descriptive analysis with clustering to identify and map feature and price data values that appear within text content of the unstructured data; and
wherein the unstructured data of the historic network communication and transaction data content comprises at least one of user survey text data, search text strings, call center notes data generated through interaction with the user, and text data appearing with social media activity data of the user.

7. The method of claim 2, further comprising:
integrating computer-readable program code into a computer system comprising the processor, a computer readable memory in circuit communication with the processor, and a computer readable storage medium in circuit communication with the processor; and
wherein the processor executes program code instructions stored on the computer-readable storage medium via the computer readable memory and thereby performs the steps of determining the user intent with respect to purchasing the item by mapping the features of the item that are indicated as desired by the user to the price values of the item that are indicated that the user will pay, identifying the features and price values of the item within data of each of the plurality of reviews of the item, assigning the positive value to each feature and price value of the reviews that are matched to features and price value of the item that are mapped in the user intent mapping, determining the helpfulness scores for each of the reviews by totaling the positive values assigned to the matched features and price values of the reviews, driving the graphical display device to display to the user the reviews prioritized with respect to their helpfulness scores, clustering the user with the plurality of different users into the customer base cluster as the function of commonalities of mappings of features to price values, and determining the links between the different features, prices and other item variable values in the reviews with high helpfulness scores relative to the score threshold or to others of the reviews that have lower helpfulness scores, to identify most valued features for prices paid by the users in the customer base cluster.

8. The method of claim 7, wherein the computer-readable program code is provided as a service in a cloud environment.

9. A system, comprising:
a processor;
a computer readable memory in circuit communication with the processor; and
a computer readable storage medium in circuit communication with the processor; and
wherein the processor executes program instructions stored on the computer-readable storage medium via the computer readable memory and thereby:
determines a user intent with respect to purchasing an item by mapping features of the item that are indicated as desired by the user, to price values of the item that are indicated that the user will pay, as a function of historic network communication and transaction data content of the user;
identifies the features and price values of the item within data of each of a plurality of reviews of the item;
assigns a positive value to each feature and price value of the reviews that are matched to features or price value of the item that are mapped in the user intent mapping;
determines helpfulness scores for each of the reviews by totaling the positive values assigned to the matched features and price values of the reviews; and
drives a graphical display device to display to the user the reviews prioritized with respect to their helpfulness scores

10. The system of claim 9, wherein the processor executes the program instructions stored on the computer-readable storage medium via the computer readable memory and thereby:
clusters the user with a plurality of different users into a customer base cluster as a function of commonalities of mappings of features to price values; and
determines links between the different features, prices and other item variable values in the reviews with high helpfulness scores relative to a score threshold or to others of the reviews that have lower helpfulness scores, to identify most valued features for prices paid by the users in the customer base cluster.

11. The system of claim 10, wherein the processor executes the program instructions stored on the computer-readable storage medium via the computer readable memory and thereby:
identifies a price point that the customer base cluster users are willing to pay for a set of features in a product as a function of a commonality of a price value within transaction data content of the customer base cluster users; and
sets a suggested retail price for a future product offering to customers of the item that includes the set of features as a function of the identified price point for the set of features.

12. The system of claim 10, wherein the processor executes the program instructions stored on the computer-readable storage medium via the computer readable memory and thereby identifies the features and the price values of the item within the data of the reviews of the item by processing unstructured text data of each of a plurality of reviews of the item, and structured ratings data of each of the reviews.

13. The system of claim 10, wherein the processor executes the program instructions stored on the computer-readable storage medium via the computer readable memory and thereby determines the user intent with respect to purchasing the item by mapping features of the item that are indicated as desired by the user to the price values of the item that are indicated that the user will pay as the function of historic network communication and transaction data content of the user by processing structured data of the historic network communication and transaction data content that comprises user cookies, user browsing history, user transaction history data that identifies features of the item that the user has previously purchased and at what price, and user demographic data linked to purchasing data and recent changes in purchasing power indicated by salary data associated with changes in user job status or in needs due to changes in family structure of the user.

14. The system of claim 10, wherein the processor executes the program instructions stored on the computer-readable storage medium via the computer readable memory and thereby determines the user intent with respect to purchasing the item by mapping features of the item that are indicated as desired by the user to the price values of the item that are indicated that the user will pay as the function of historic network communication and transaction data content of the user by processing unstructured data of the historic network communication and transaction data content by applying at least one of natural language processing text analysis, psycholinguistic analysis, and descriptive analysis with clustering to identify and map feature and price data values that appear within text content of the unstructured data; and
wherein the unstructured data of the historic network communication and transaction data content comprises at least one of user survey text data, search text strings, call center notes data generated through interaction with the user, and text data appearing with social media activity data of the user.

15. A computer program product for prioritizing and weighting model contextual influencing factors for energy load forecasting, the computer program product comprising:
a computer readable storage medium having computer readable program code embodied therewith, wherein the computer readable storage medium is not a transitory signal per se, the computer readable program code comprising instructions for execution by a processor that cause the processor to:
determine a user intent with respect to purchasing an item by mapping features of the item that are indicated as desired by the user, to price values of the item that are indicated that the user will pay, as a function of historic network communication and transaction data content of the user;
identify the features and price values of the item within data of each of a plurality of reviews of the item;
assign a positive value to each feature and price value of the reviews that are matched to features or price value of the item that are mapped in the user intent mapping;
determine helpfulness scores for each of the reviews by totaling the positive values assigned to the matched features and price values of the reviews; and
drive a graphical display device to display to the user the reviews prioritized with respect to their helpfulness scores

16. The computer program product of claim 15, wherein the computer readable program code instructions for execution by the processor further cause the processor to:
cluster the user with a plurality of different users into a customer base cluster as a function of commonalities of mappings of features to price values; and
determine links between the different features, prices and other item variable values in the reviews with high helpfulness scores relative to a score threshold or to others of the reviews that have lower helpfulness scores, to identify most valued features for prices paid by the users in the customer base cluster.

17. The computer program product of claim 16, wherein the computer readable program code instructions for execution by the processor further cause the processor to:
identify a price point that the customer base cluster users are willing to pay for a set of features in a product as a function of a commonality of a price value within transaction data content of the customer base cluster users; and
set a suggested retail price for a future product offering to customers of the item that includes the set of features as a function of the identified price point for the set of features.

18. The computer program product of claim 16, wherein the computer readable program code instructions for execution by the processor further cause the processor to identify the features and the price values of the item within the data of the reviews of the item by processing unstructured text data of each of a plurality of reviews of the item, and structured ratings data of each of the reviews.

19. The computer program product of claim 16, wherein the computer readable program code instructions for execution by the processor further cause the processor to determine the user intent with respect to purchasing the item by mapping features of the item that are indicated as desired by the user to the price values of the item that are indicated that the user will pay as the function of historic network communication and transaction data content of the user by processing structured data of the historic network communication and transaction data content that comprises user cookies, user browsing history, user transaction history data that identifies features of the item that the user has previously purchased and at what price, and user demographic data linked to purchasing data and recent changes in purchasing power indicated by salary data associated with changes in user job status or in needs due to changes in family structure of the user.

20. The computer program product of claim 16, wherein the computer readable program code instructions for execution by the processor further cause the processor to determine the user intent with respect to purchasing the item by mapping features of the item that are indicated as desired by the user to the price values of the item that are indicated that the user will pay as the function of historic network communication and transaction data content of the user by processing unstructured data of the historic network communication and transaction data content by applying at least one of natural language processing text analysis, psycholinguistic analysis, and descriptive analysis with clustering to identify and map feature and price data values that appear within text content of the unstructured data; and
wherein the unstructured data of the historic network communication and transaction data content comprises at least one of user survey text data, search text strings, call center notes data generated through interaction with the user, and text data appearing with social media activity data of the user.
